(19) United States
(12) Patent Application Publication
(10) Pub. No.: US 2018/0129226 A1
(43) Pub. Date: May 10, 2018

(54) HELICOPTER AUTOROTATION CONTROLLER

(71) Applicant: THE TEXAS A&M UNIVERSITY SYSTEM, College Station, TX (US)

(72) Inventors: Jonathan David Rogers, College Station, TX (US); Zachary Nolan Sunberg, Longmont, CO (US)

(21) Appl. No.: 14/305,413

(22) Filed: Jun. 16, 2014

Related U.S. Application Data
(60) Provisional application No. 61/835,398, filed on Jun. 14, 2013.

(51) Int. Cl. G05D 1/10; B64D 25/00; B64C 27/57

(52) U.S. Cl. CPC G05D 1/105; B64C 27/04; B64C 27/57; B64D 25/00

(57) ABSTRACT

A helicopter auto-pilot or autonomous flight system can include an autorotation controller configured to adjust a desired trajectory based on a predicted time to ground impact value continuously calculated in response to a failure event. A multi-phase approach can be used in which the calculations for adjusting the desired trajectory depend on the time to ground impact value. In one case, the phases include steady state descent, flare, and touchdown. Flare descent can be fully automated by calculating the time needed to slow the helicopter before entering a landing phase and generating an altitude trajectory (along with control inputs for the helicopter) that will cause the vehicle to land at an appropriate time (the current time plus a prescribed time to impact).

### CROSS-REFERENCE TO RELATED APPLICATION

The present application claims the benefit of U.S. Provisional Application Ser. No. 61/835,398, filed Jun. 14, 2013, which is hereby incorporated by reference herein in its entirety, including any figures, tables, or drawings.

### BACKGROUND

Helicopters are aircraft that enable vertical takeoff and landing through the use of rotors. However, because vertical lift is derived directly from main rotor thrust (rather than indirectly through a wing such as in fixed-wing aircraft), helicopters can be much less forgiving than conventional aircraft in the event of power loss.

Autorotation is a series of maneuvers performed by a helicopter in the event of engine, transmission, or tail rotor failure. During an autorotation descent, rotor blades are driven solely by the upward flow of air through the rotor because the engine is no longer supplying power to the main rotor.

When a single engine helicopter encounters engine failure, or when any helicopter suffers a catastrophic transmission or tail rotor failure, a pilot performs autorotation maneuvers to bring the helicopter to a safe landing. In the autorotation maneuver, the engine does not provide power to the main rotor. Instead, the pilot uses the air flowing through the rotor to maintain main rotor kinetic energy, enabling some measure of control of the aircraft and allowing the pilot to slow the helicopter before landing to minimize total velocity at impact.

When landing during autorotation, the only energy available to slow the rate of descent and provide for a soft landing is the kinetic energy stored in the rotor blades. Stopping a helicopter with a high rate of descent requires more energy than stopping a helicopter that is descending more slowly, resulting in lower margins for error when performing autorotative descents at very low or very high airspeeds (as compared to the airspeed at which the helicopter requires minimum power, which provides for the slowest descent rate).

The autorotation maneuver requires significant pilot skill to avoid loss of life or extreme damage to the vehicle; thus, historically, the autorotation maneuver has not been carried out by automatic control systems. One critical autorotation maneuver, which must be precisely timed to avoid large impact velocities, is the flare maneuver. The flare maneuver involves increasing the blade pitch near the ground to slow vertical and horizontal velocity. Indeed, real time computations for achieving a feasible flare trajectory can be difficult due to the high dimensionality of the problem, the limited computational resources likely to be available, and the likelihood of external disturbances such as gusts.

As single engine autonomous rotorcraft of all sizes become more prevalent, automatic control laws and systems for autorotation that protect expensive equipment and possibly human passengers in cases of engine failure are needed.

### BRIEF SUMMARY

Autorotative techniques and systems for automated autorotation descent are provided. According to various embodiments of the invention, an autorotation controller is described that generates control signals according to a continuously updated set of time-to-ground impact calculations. As the time-to-ground impact is updated, a trajectory path is adjusted based on the updated time-to-ground impact and used to adjust the helicopter controls.

A multi-phase approach is described that includes steady state descent, flare, and touchdown phases. Pre-flare and landing phases may also be included.

Each phase contains its own set of control laws mapping inputs to outputs. The controller uses some combination of forward speed, rotor rotation rate, vertical velocity, and altitude as inputs depending on the specific phase. The controller outputs a desired translational velocity and desired collective or change in the collective setting.

Predicted time to impact can be computed throughout the maneuver, and used, in some embodiments, with height above ground, to initiate transitions between these phases. During the flare phase, the controller uses a measure of the helicopter kinetic energy to compute a prescribed desired time to impact, which defines a specific flare trajectory.

The controller can be combined with a velocity tracking controller (which may be part of an autopilot system of a helicopter) and/or a path planning algorithm to locate a safe landing location.

Furthermore, the controller is highly scalable and can be implemented on full-sized manned helicopters and small-scale UAV's or hobby helicopters. A small subset of parameters is tuned within the control algorithm, but control performance is relatively insensitive to many of these parameters. Applications of the autorotation controller include incorporation within a fully-autonomous controller (no pilot in the loop), strict pilot guidance (no autonomous control), or some compromise of the two.

This autorotation control algorithm could be easily integrated into production autopilots for autonomous rotorcraft vehicles and/or for manned aircraft. Currently, these autopilots are sold worldwide to aircraft manufacturers both in the UAV industry and the manned aircraft industry. Embodiments facilitate a safe helicopter landing in the event of engine failure. Since most autopilots already have a control system that can maintain a commanded velocity, the autorotation controller can be easily implemented as a separate module that provides commands to the current autopilot velocity controller.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a process flow of a controller according to an embodiment of the invention.

FIG. 2A illustrates an autorotation controller according to an embodiment.

FIG. 2B illustrates an autopilot system incorporating an autorotation module according to an embodiment.

FIG. 3 illustrates a control scheme architecture of an embodiment of the invention.

FIG. 4 illustrates a velocity tracking controller to which an autorotation controller of an embodiment may communicate.

FIG. 5 illustrates a process flow for an autorotation maneuver.

FIG. 6A shows a block diagram for autorotation control during a flare maneuver according to an embodiment.

FIG. 6B illustrates a process flow for determining time to landing phase entry (TTLE) during a flare maneuver according to an embodiment.

FIG. 7 shows a sample actuator response.

FIG. 8 shows a set of kinematic state histories for a sample autorotation simulation of an AH-1G helicopter.

FIGS. 9A-9C show plots of helicopter state histories for a sample AH-1G autorotation simulation.

FIGS. 10A-10D show plots of control histories for a sample autorotation simulation of an AH-1G helicopter.

FIG. 11 shows a plot indicating phase control authority over time from engine stop.

FIG. 12 shows a plot of time from engine stop vs. time to impact for controller internal time to impact variables of an embodiment.

FIG. 13 shows a Monte Carlo simulation plot (0s handoff delay).

FIG. 14 shows a Monte Carlo simulation plot (1s handoff delay).

FIG. 15 shows a Monte Carlo simulation plot (2s handoff delay).

FIG. 16 shows a Monte Carlo simulation plot (Overweight).

FIG. 17 shows a set of state histories for a sample autorotation simulation of an Align T-Rex 600 RC Helicopter.

FIG. 18 shows a plot of rotor rotation rate history for a sample autorotation simulation of an Align T-Rex 600 RC Helicopter.

FIG. 19A-19D show plots of control histories for a sample autorotation simulation of an Align T-Rex 600 RC Helicopter.

### DETAILED DISCLOSURE

Autorotative techniques and systems for automated autorotation descent are provided. According to various embodiments of the invention, an autorotation controller is described that generates control signals according to a continuously updated set of time-to-ground impact calculations. As the time-to-ground impact is updated, a trajectory path is adjusted based on the updated time-to-ground impact and used to adjust the helicopter controls.

A control system is presented that uses a nonlinear mapping between measured states and control outputs that does not require any iterative calculation or prediction using a complex model. Various implementations are scalable to any single main rotor helicopter—from a micro-air-vehicle to a full-size utility helicopter.

An autorotative descent generally involves entry into autorotation, a steady state descent towards a suitable landing site, and a flaring (“flare”) maneuver to dramatically reduce kinetic energy immediately before landing. If entry into the autorotation is delayed or if the maneuver is otherwise executed poorly, the rotor rotation speed may drop to a level that is too low for proper control, provides insufficient energy for the flare or leads to excessive blade flapping. These considerations result in a set of restricted height and velocity combinations known as “dead man's curve,” typically plotted on a Height-Velocity (H-V) diagram, from which a successful autorotation is unlikely. The H-V diagram may be different for each type of helicopter, but is most significant for single engine rotorcraft.

There are many scenarios where a helicopter operates at heights and speeds within the dead man's curve of a H-V diagram for a particular rotorcraft. For example, a helicopter may operate within an “avoid” region of the H-V diagram when filming aerial shots, performing powerline maintenance, emergency rescue or fire fighting.

Certain embodiments can facilitate automated forward flight to reduce the descent rate or maneuver to a landing site. These techniques can be carried out by an autorotation controller. Certain embodiments do not use training data or perform iterative optimization of flight trajectories before adjusting the flight controls.

The autorotation controller can be implemented as a closed-loop system on a fully-autonomous vehicle, or may provide guidance to a human pilot. In some embodiments, the guidance from the autorotation controller can be used by human pilots to autorotate safely from well within the “avoid” region of the H-V diagram by providing real-time guidance in an advanced avionics system. In some embodiments, the autorotation controller can be used in an unmanned rotorcraft or during fully automated autorotation descent to touchdown.

The autorotation controller may be an independent controller or may be implemented as part of another helicopter control system. Aspects may be implemented in hardware, software, or a combination of hardware and software.

Various embodiments may be implemented with additional functionality including, but not limited to, finding a suitable landing site and navigating to the site or incorporating a path planning algorithm as part of the autopilot system, both of which may involve taking the output of a steady-state descent controller described herein to adjust and select a landing site.

An autorotation controller is provided that can, upon a failure condition (e.g., engine failure), initiate autorotation maneuvers for safe landing and touchdown. The autorotation controller of certain embodiments uses a prescribed time to impact calculation to provide control outputs to the helicopter flight controls. The prescribed time to impact calculations can be based on a determined autorotation descent region.

An autorotation descent region refers to a region, or phase, of descent in which a common response is performed. In one implementation, the autorotation maneuver is divided into five regions (in which the helicopter is in autorotation descent) based on the altitude, h, and the predicted time to impact assuming constant velocity, TTI_{\dot{h}=0}≡−h/\dot{h}. These regions represent the phases of the autorotation maneuver that the pilot would progress through. For example, the five phases can be steady state descent, pre-flare, flare, landing, and touchdown. The transitions between the phases may involve different altitude and time-to-impact ranges.

It should be understood that more or fewer regions may be used without departing from the spirit of the invention. Indeed, each helicopter may have different flight phases—as well as different transition regions (and ranges for those transitions).

The boundaries and features of the flight phases may be tuned and/or defined using intuition, flight experience, test data, and simulation to achieve acceptable results for a wide range of helicopters—both manned and unmanned.

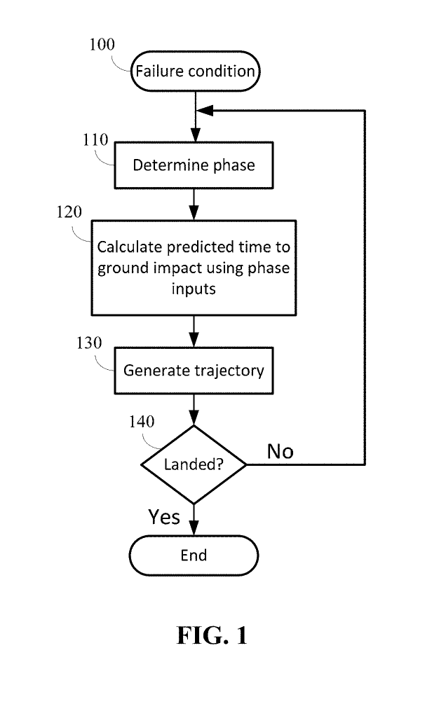

FIG. 1 illustrates a process flow of a controller according to an embodiment. As shown in FIG. 1, in response to a failure condition (100), the controller can determine the autorotation phase (110) and calculate a predicted time to ground impact using the inputs (and calculations) indicated by the determined phase (120). According to certain embodiments, the phases are defined by regions of a descent phase diagram based on altitude and time-to-impact at a constant velocity. As described above, in some implementations, five phases may be defined: steady state, pre-flare, flare, landing, and touchdown. More or fewer phases may be defined in different implementations. Depending on the determined phase, different inputs are used to prescribe the desired time to ground impact. Using this prescribed time to ground impact, a trajectory (e.g., main rotor collective pitch or rate of change of collective pitch) can be generated (130). This process can be continuously repeated while the helicopter has not yet landed (140).

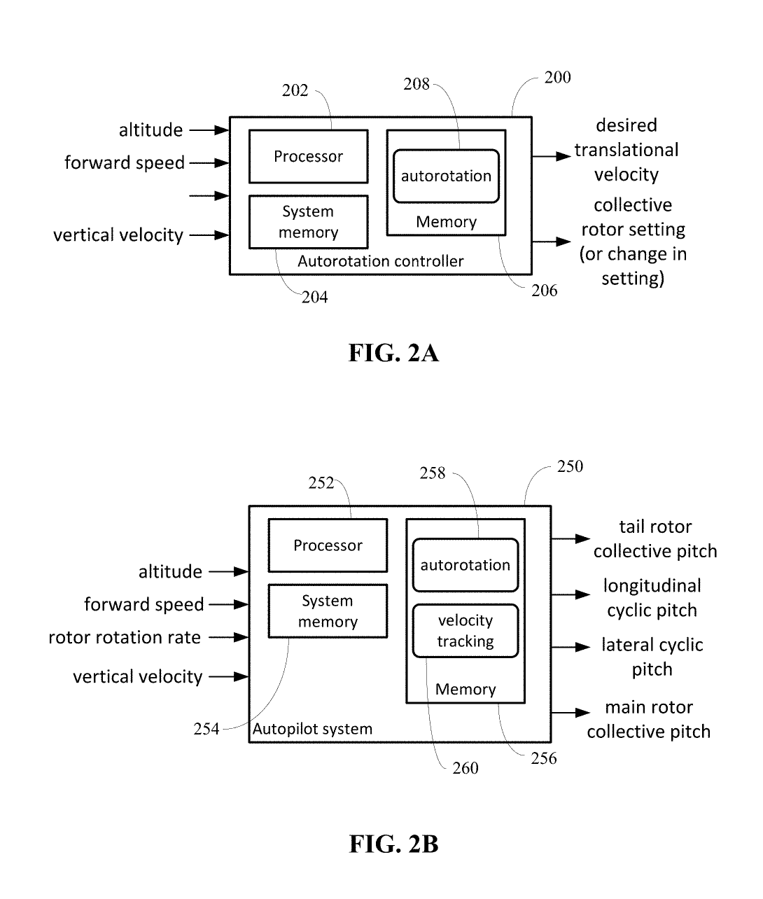

FIG. 2A illustrates an autorotation controller according to an embodiment; FIG. 2B illustrates an autopilot system incorporating an autorotation module according to an embodiment. Referring to FIG. 2A, an autorotation controller 200 can include a processor 202, system memory (cache/buffer) 204, and a main memory 206 on which instructions for performing a method of automated autorotation is stored (e.g., autorotation program 208). In another embodiment, some or all of the autorotation program may be implemented in hardware, for example, using a FPGA or system on a chip (SoC). In yet other embodiments, each descent phase may have an associated controller (implemented in hardware or software).

For the implementation illustrated in FIG. 2A, available inputs to the autorotation controller 200 include altitude, forward speed, rotor rotation rate, and vertical velocity. The output of the autorotation controller 200 can include, in one embodiment, the collective rotor setting or, in another embodiment, a change in collective rotor setting, providing control signals for a main rotor collective pitch. The output of the autorotation controller 200 can also include a desired translational velocity (e.g., desired forward speed value) that can be used to generate control values for adjusting the helicopter controls involving, for example, tail rotor collective pitch, lateral cyclic pitch, and longitudinal cyclic pitch. A separate controller (or controllers) may be available for performing velocity tracking and/or path planning) by using the translational velocity provided by the autorotation controller 200. The separate controller(s) may include their own processors and/or memory components.

Referring to FIG. 2B, an autopilot system 250 can include a processor 252, system memory (cache/buffer) 254, and a main memory 256 on which instructions for performing autonomous piloting can be stored. The instructions can include instructions for a method of automated autorotation (e.g., autorotation program 258) and a velocity tracking (and/or path planning) program 260. In the embodiment illustrated in FIG. 2B, the autorotation controller is part of an autopilot system and may not be a separate controller from other control systems of the rotorcraft. As with the autorotation controller described in FIG. 2A, in other embodiments of the autopilot system, some or all of the autorotation program may be implemented in hardware, for example, using a FPGA or system on a chip (SoC).

For the implementation illustrated in FIG. 2B, available inputs to the autopilot system 250 for use by the autorotation controller/program 258 include altitude, forward speed, rotor rotation rate, and vertical velocity. The output of the autopilot system 250 can include tail rotor collective pitch, cyclic pitch (e.g., longitudinal cyclic pitch and lateral cyclic pitch), and main rotor collective pitch. The autorotation controller/program 258 may directly provide the main rotor collective pitch or adjustments to a collective pitch trim setpoint.

Basic Nomenclature used in describing the operating environment and controller is as follows:

h=altitude above ground level

K=gain

TTI=time to impact

u=forward velocity

β=blade flapping angle

λ=induced inflow ratio

μ=fuzzy membership function

θ=pitch angle

θ₀=main rotor collective pitch

θ₁ₛ=longitudinal cyclic pitch

θ_{1c}=lateral cyclic pitch

θ_{TR}=tail rotor collective pitch

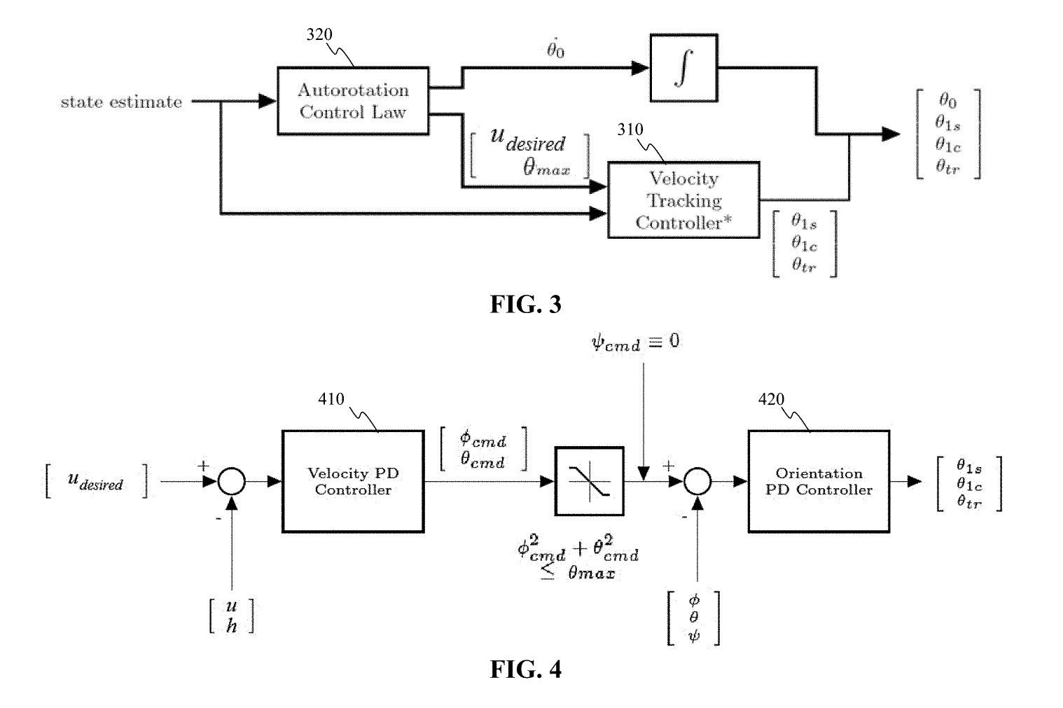

FIG. 3 illustrates a control scheme architecture of an embodiment of the invention. The autorotation control law (selected by the autorotation controller such as described with respect to FIGS. 1-2) determines θ₀ while the velocity tracking controller determines the cyclic and tail rotor commands with input from the autorotation control law.

Referring to FIG. 3, the control inputs to the helicopter from an autopilot control system may include a main rotor collective pitch, θ₀, a longitudinal cyclic pitch, θ₁ₛ, a lateral cyclic pitch, θ_{1c}, and a tail rotor collective pitch, θₜᵣ. Horizontal velocity, sideward velocity, and yaw control of the helicopter can be handled by a standard inner-outer loop flight controller, which can be referred to as a velocity tracking controller 310.

The velocity tracking controller 310 may be any suitable controller. The velocity tracking controller can be based on any control approach from a neural network to a simple proportional-integral-derivative (PID) controller. Various embodiments of the invention may be implemented in a system used in normal powered flight. An additional outer-loop control block may be added to handle path planning to a suitable landing site during the steady-state descent phase.

For example, FIG. 4 illustrates a simple velocity tracking controller to which an autorotation controller of an embodiment may communicate. The controller illustrated in FIG. 4 was used as an example in the simulations. In many cases, the velocity tracking controller can be implemented by a controller designed for powered flight of the particular helicopter or by a complex controller designed to automatically find a suitable landing site. The reference controller shown in FIG. 4 uses a two-tiered proportional derivative (PD) scheme. The outer loop (velocity PD controller 410) recommends an orientation ([ϕ_{cmd}, θ_{cmd}, ψ_{cmd}]^{T}) based on the desired forward velocity u_{desired} and the current helicopter velocity (e.g., horizontal and vertical velocities u and h). The inner loop (orientation PD controller 420) attempts to match this orientation using the cyclic and tail rotor controls ([θ₁ₛ, θ_{1c}, θₜᵣ]^{T}).

Returning to FIG. 3, an autorotation controller 320 of an embodiment of the invention recommends a desired near-optimal forward speed (u_{desired}) to the helicopter velocity tracking controller 310, which tracks these commands through longitudinal and lateral cyclic inputs. In a further embodiment, a maximum cap on the pitch and roll angles (θₘₐₓ) is imposed to prevent drastic maneuvers in certain conditions such as in close proximity to the ground.

The autorotation controller 320 directly handles the main rotor collective θ₀ (instead of relying on the velocity tracking controller) since the collective pitch (θ₀) is a critical control input affecting the rotor rotational speed, Ω, which should be carefully managed during autorotation.

Since the desirable set point of the main rotor collective is highly dependent upon the helicopter mass and other parameters (which may be unknown at flight time), each phase-specific control law of the autorotation controller may actually recommend an adjustment to θ₀, observing the results to seek a suitable trim value for θ₀ in much the same way that a human pilot would make adjustments. Thus, the outputs of the autorotation controller for each flight phase, in this embodiment, are a main rotor collective pitch derivative, \dot{θ}₀, a desired forward velocity, u_{desired}, and maximum pitch and roll angle, θₘₐₓ. In some embodiments, the autorotation control outputs the main rotor collective pitch θ₀ directly instead of the derivative \dot{θ}₀.

In more detail, the autorotation controller can perform descent phase based calculations to generate a desired trajectory and automate autorotation flight through touchdown, including flare.

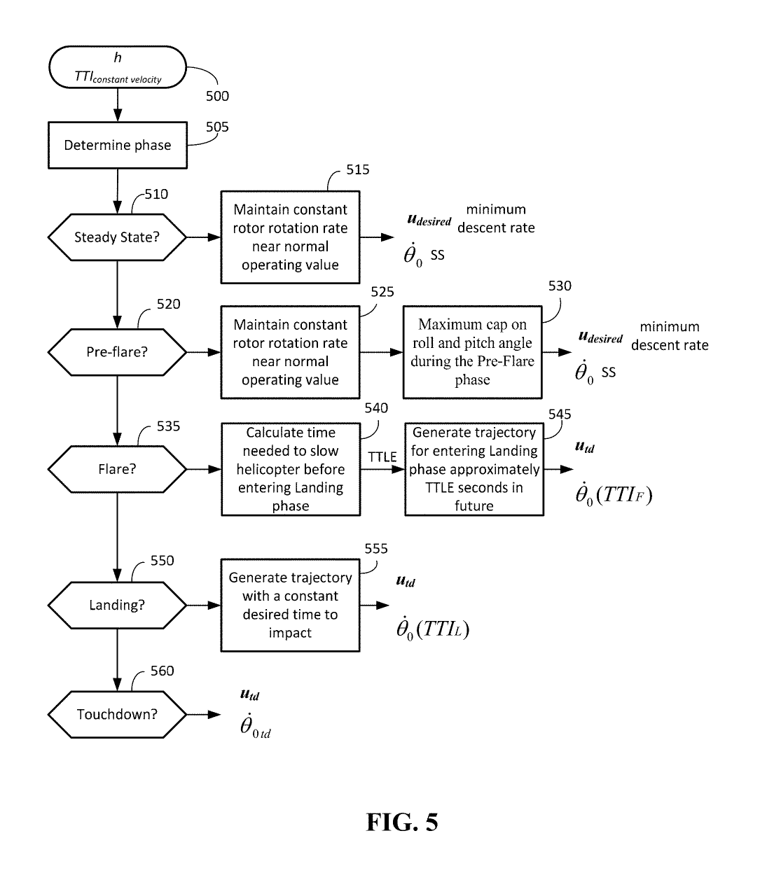

FIG. 5 illustrates a process flow for an autorotation maneuver. An autorotation operation (500) can begin upon receipt of the helicopter's altitude h and vertical speed, which is used to calculate time to impact assuming constant velocity (−h/\dot{h}) and determine the phase (505) in which the helicopter is operating after a failure event (e.g., 100 and 110 of FIG. 1). Each rotorcraft may have a different break-down for what constitutes each phase. When determining the phase (505), the autorotation controller uses the values given for the rotorcraft to which the autorotation controller forms a part.

If the helicopter is in a steady state (510), the controller maintains constant rotor rotation rate near the normal operating value (515) and achieves a desired forward speed for a minimum descent rate and a steady state collective pitch.

When the helicopter reaches pre-flare (520), the controller continues to maintain constant rotor rotation rate near the normal operating value (525), tracks a desired forward speed for a minimum descent rate, and imposes a maximum value on the roll and pitch angle (530).

Once the helicopter reaches flare (535), the time needed to slow the helicopter before entering the landing phase (TTLE) 540 is calculated and a trajectory for entering the landing phase approximately TTLE seconds in the future is generated to provide a desired forward speed for the touchdown phase and a collective pitch angle or collective pitch derivative that is a function of the prescribed time to impact in the flare phase.

After the flare phase, a landing phase (550) may be entered, in which a trajectory is generated with a constant desired time to impact (555). The controller, while in the landing phase, provides a desired forward speed and a collective pitch angle or collective pitch derivative that is a function of the desired time to impact during the landing phase.

The final phase is touchdown (560), which provides a constant collective pitch angle or collective pitch rate.

Each flight phase involves associated calculations and parameters. Table 1 presents a listing of parameters and their associated brief descriptions. Specific implementations of the flight phases are discussed in more detail in the following descriptions.

TABLE 1
Controller Parameters and description

| Parameter | Description |
|---|---|
| u_{min descent rate} | Forward speed for minimum descent rate (near the |
| | recommended speed for autorotation for the helicopter) |
| K_{DSS} | Gain on rotor speed time derivative for collective |
| | control during steady-state descent |
| K_{PSS} | Gain on rotor speed for collective control during |
| | steady-state descent |
| Pre-Flare θₘₐₓ | Maximum cap on roll and pitch angle during the Pre- |
| | Flare phase |
| K_{θ0} | Rotor collective gain for Flare and Landing phases |
| τ | Rotor collective adjustment time constant tuning |
| | parameter for Flare and Landing phases |
| \dot{θ}_{0fast} | Collective adjustment rate for rapid adjustments during |
| | the Flare and Landing phase |
| TTLEₘₐₓ | Maximum cap on the desired time to Landing entry |
| | during the Flare phase |
| TTI_{L} | Prescribed desired time to impact during the Landing |
| | phase |
| Landing θₘₐₓ | Maximum cap on roll and pitch angles during the |
| | Landing phase |
| \dot{θ}_{0td} | Constant collective pitch rate during Touchdown phase |
| u_{td} | Desired forward velocity at touchdown |
| Touchdown θₘₐₓ | Maximum cap on roll and pitch angles during the |
| | Touchdown phase |

### Steady State Descent

In the Steady State Descent phase, the controller seeks to maintain a constant rotor rotation rate near the normal operating value while the helicopter maneuvers to a suitable landing site. In some embodiments, a path planning algorithm can be used to compute feasible paths to a landing site. In some embodiments without a path planning algorithm, the controller can match the forward speed u_{min descent rate} that will result in the slowest rate of descent. The following equations define the control output in this phase for the case where the controller is matching the forward speed resulting in the slowest rate of descent:

u_{desired}=u_{min descent rate}

\dot{θ}₀=K_{Dss}\dot{Ω}+K_{Pss}(Ω−Ω_{ss,desired})

θₘₐₓ=limited only by horizontal controller .

The speed for slowest descent rate u_{min descent rate} is the forward speed at which the required power in steady-state forward flight is minimized. Generally this is near the recommended forward speed for autorotation given in the flight manual for a manned helicopter. The desired steady state rotor rotation rate Ω_{ss,desired} can be set to the normal operating rotor rotation rate, or an increased value if more energy is desired for flare and the value is not above structural limits. The derivative of collective pitch \dot{θ}₀ can be governed by a simple PD linear controller, which drives it toward an unknown value corresponding to trimmed autorotation. This is effectively equivalent to governing θ₀ using a proportional-integral(PI) controller (see also FIG. 3).

The gains K_{Dss} and K_{Pss} can be chosen using conventional control techniques with a simplified model or tuned by hand using a high fidelity simulation model since the plant is nonlinear. In general, if gains are chosen appropriately, this control law will be stable in the normal operating region where the steady state rotor rotation rate decreases if θ₀ increases (dΩₛₛ/dθ₀<0).

For some model size aerobatic helicopters, there is a region of large negative θ₀ where a decrease in collective pitch will decrease the steady state rotation rate (dΩₛₛ/dθ₀<0). In this region, the controller will fail. K_{Dss} can be selected to be large enough so that θ₀ does not overshoot the target value corresponding to Ω_{ss,desired} by too large a margin. Otherwise, an additional control constraint can be introduced to inhibit θ₀ from overshooting the target value corresponding to Ω_{ss,desired} by too large a margin.

This control law is designed to maintain an appropriate rotor rotational rate regardless of the forward speed of the helicopter or maneuvers used to reach a safe landing site. Simulation tests and flight experiments have shown that it is able to adjust θ₀ to suit a range of steady state forward speeds.

### Pre-Flare

During the pre-flare phase, the controller attempts to bring the helicopter state into the subspace that will likely result in a successful flare. The pre-flare controller (e.g., the autorotation controller operating in the pre-flare phase) can be identical to the steady state descent controller (e.g., the autorotation controller operating in the steady state descent phase) except that it instructs the velocity tracking controller to limit its maneuvers to a small roll or bank angle so that it is not attempting drastic maneuvers when entering the flare phase. The following equations define control output in this phase:

u_{desired}=u_{min descent rate}

\dot{θ}₀=K_{Dss}\dot{Ω}+K_{Pss}(Ω−Ω_{ss,desired})

θₘₐₓ=Pre Flare θₘₐₓ(controller parameter).

### Flare

The flare phase may, in some cases, be the most critical part of the autorotation maneuver and proper timing is vital. A goal of the flare phase is to reduce the vertical and horizontal velocities to values suitable for safe entry into the landing phase. The velocity tracking controller is instructed (given a desired forward velocity from the autorotation controller) to bring the helicopter to the small translational velocity value desired for landing.

The remaining task for the autorotation controller is to determine and track a vertical trajectory that will cause the helicopter to enter the landing phase at the same time that the velocity tracking controller reaches the desired speed (u_{td}).

It has been acknowledged in the literature that determining a feasible flare trajectory is a challenge. One approach to handle this challenge has been to use data from actual autorotations performed by a human pilot to determine a feasible trajectory. While this strategy has been shown to be successful, it requires the capture of training data and the associated data reduction and analysis for each specific vehicle under consideration. Various embodiments of the invention avoid the capturing of training data as well as having to directly specify a feasible trajectory in the space of a helicopter's physical state. Instead, “time-to-impact” is prescribed (e.g., calculated or determined by the system) and used to generate a trajectory.

Table 2 presents time-to-impact variables used in the flare control law for an embodiment of the invention.

TABLE 2

| Variable | Physical Meaning | Source | Use |
|---|---|---|---|
| TTI_{\ddot{h}=0} | Estimated time to | Calculated based | Determining |
| (TTI at | impact assuming | on measured | which phase the |
| constant | vertical speed | helicopter state | helicopter is in |
| speed) | remains constant | | |
| TTI_{L} | Desired time to | Tunable control | In Landing phase |
| | impact during the | law parameter | control law |
| | Landing phase | | |
| TTLE | Desired time to | Determined | Determines TTI_{F} |
| | Landing phase | using Algorithm | |
| | entry | 1 (FIG. 3) | |
| TTI_{F} | Desired time to | TTI_{F} ≡ TTI_{L} + | In Flare phase |
| | impact during | TTLE | control law |
| | Flare phase | | |

The tasks of the flare phase controller are to A) determine a suitable value for TTLE, the additional time needed to slow the helicopter before entering the landing phase, and B) apply control inputs to the helicopter that will put the helicopter on a trajectory to enter the landing phase approximately TTLE seconds in the future.

According to embodiments of the invention, the flare control law first estimates how long it will take for the velocity tracking controller to complete the flare while also taking energy constraints into account. Then the flare control law determines a collective command sequence to bring the helicopter to the landing phase in approximately that amount of time. Some example methods for performing these tasks (and calculating TTLE and \dot{θ}₀) are described; however, embodiments are not limited thereto where approximate reasoning in the time-to-impact domain is utilized.

According to an example method, to determine a suitable value for TTLE (task A), the controller begins with the amount of time needed to reach the desired vertical and horizontal speeds for landing phase entry if accelerations were to remain constant. Constraints may then be applied to condition the value, which can be used to determine a control value for assisting the helicopter to enter the landing phase approximately TTLE seconds from the current time (task B).

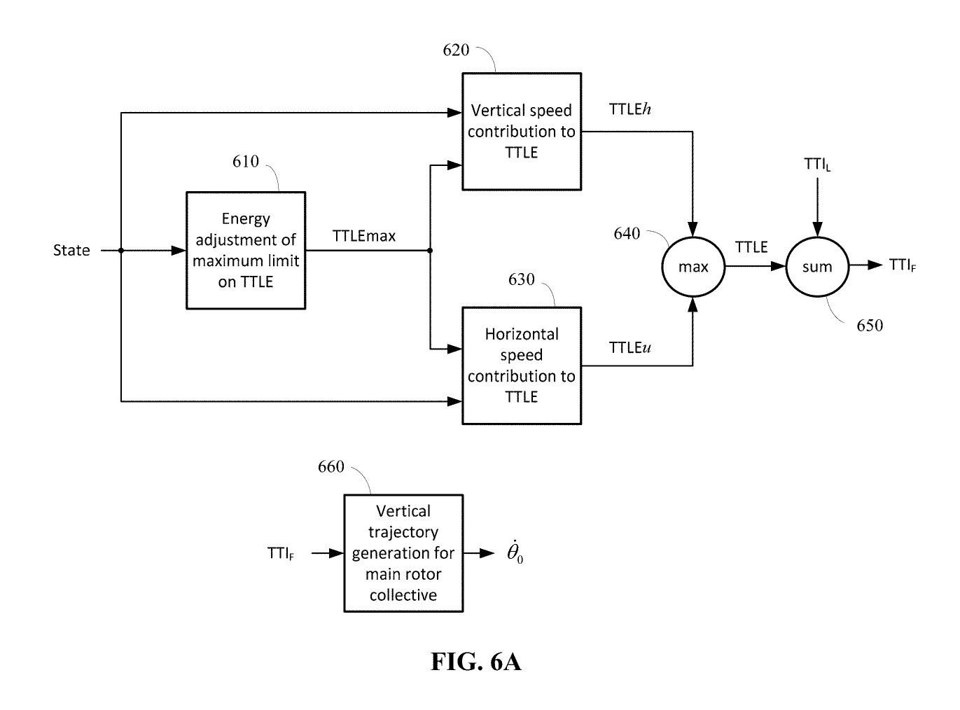

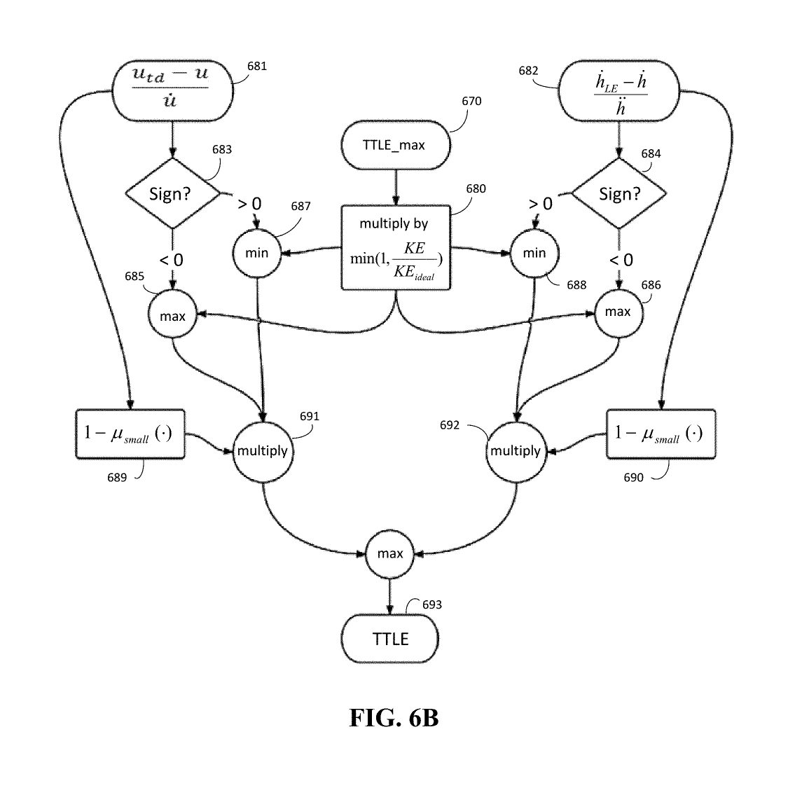

FIG. 6A shows a block diagram for autorotation control during a flare maneuver according to an embodiment. Referring to FIG. 6A, for a given state (e.g., a altitude, forward velocity, vertical velocity, and rotor speed), a desired time to landing phase entry (TTLE) is generated and an energy adjustment of a maximum limit on TTLE is performed (610), giving TTLEmax. Then, the vertical speed contribution to TTLE (620) and the horizontal speed contribution to TTLE (630) are analyzed using the given state and TTLEmax. The maximum value for the vertical speed contribution TTLEh and the horizontal speed contribution TTLEu are computed (640) to obtain TTLE. TTLE can be summed (650) with the tunable parameter TTI_{L}, which is the desired time to impact during the landing phase, to obtain TTI_{F}, which is the desired time to impact during the flare phase. TTI_{F} is then used to perform vertical trajectory generation (660) for the main rotor collective (as θ₀ or \dot{θ}₀).

FIG. 6B illustrates a process flow for determining time to landing phase entry (TTLE) during a flare maneuver according to an embodiment. The process flow illustrated in FIG. 6B can be one implementation of blocks 610, 620, 630, and 640 of FIG. 6A.

Details of a specific implementation are provided as follows (with reference to FIG. 6B):

Initially, the desired time to landing phase entry (TTLE) is given by:

$$TTLE = max ( \frac{{\dot{h}}_{LE} - \dot{h}}{\ddot{h}} , \frac{{u}_{td} - u}{\dot{u}} ) .$$

The desired horizontal speed (at landing phase entry) is u_{td}, the current forward speed is u, the horizontal acceleration is \dot{u}, the current vertical velocity is \dot{h}, the vertical acceleration is \ddot{h}, and the desired vertical speed is \dot{h}_{LE}≡h_{LE}/TTI_{L} where h_{LE} is defined as the altitude midway through the transition between the flare and landing phases.

Referring to FIG. 6B, as part of the process flow for calculating TTLE, the values for horizontal speed (681) and vertical speed (682) from the initial TTLE (670) can be analyzed and/or processed to apply constraints.

For example, one constraint may involve the energy available to the helicopter (e.g., kinetic energy). This constraint may be applied to the initial TTLE in operation (680).

Another constraint may involve the sign. The sign of the horizontal speed derivative \ddot{h} and the vertical speed derivative \dot{u} can be indicative of whether the helicopter physical state is moving away from or toward the desired state.

The sign of the horizontal acceleration \dot{u} can be checked (683) and the sign of the vertical acceleration \ddot{h} can be checked (684). If either of the calculations in block 681 or 682 has a negative sign (e.g., <0), it means that the helicopter physical state is moving away from the desired state. In this case, TTLE can be set to a maximum value (685, 686), representing the longest amount of time that the helicopter would be expected to carry out maneuvers to reach the desired speed. This maximum value is the controller parameter TTLEₘₐₓ.

If both values in 681 and 682 have a positive sign, (687, 688), the TTLE is within the constraint. However, if the values have a positive sign (e.g., >0), but are very large, TTLE can be capped at a maximum value of TTLEₘₐₓ. The rules related to sign enforce the following constraints (however the constraints do not completely describe the rules)

0≤TTLE≤TTLEₘₐₓ.

Because of this sign constraint and use of the TTLEₘₐₓ parameter, if the actual helicopter velocities are near the desired velocities but one of the accelerations has the wrong sign, TTLE may be set to a large value even though the desired state is very close. In order to avoid or minimize this undesirable behavior and produce a behavior where the helicopter enters the landing phase regardless of the acceleration when the helicopter has reached a velocity near the desired velocity, a fuzzy set of small velocities or short times is defined (i.e., a set of small velocities or short times that have degrees of membership).

To the degree that TTLE lies within this set, TTLE is limited to zero. That is, when both components of velocity (vertical and horizontal) are within the set, TTLE is set to zero. The set is defined by the membership function μₛₘₐₗₗ. According to one implementation, this is a trapezoidal membership function with a support of, for example, (−3 s, 3 s) and shoulders, for example, at ±1 s. In another implementation, the trapezoidal membership function uses the support of, for example, (−6 ft/s, 3 ft/s) and shoulders, for example, at ±2 ft/s. Thus, the horizontal and vertical speed values (681, 682) are checked against the fuzzy set (689, 690).

As mentioned above with respect to operation 680, the amount of energy available to the helicopter is also taken into account. When the helicopter is autorotating from an initial state within the “avoid” region of the H-V curve, the rotor speed and forward velocity may be too low to allow a normal flare to take place. Instead, the helicopter will be forced to rapidly increase collective very late in the descent and land with whatever horizontal velocity it has. In other words, landing with a small vertical velocity is the highest priority; landing with a low horizontal velocity is a secondary consideration. Based on this desired relationship, the total kinetic energy of the helicopter can be defined as the sum of the translational energy and the rotational energy of the rotor:

KE=1/2mv·v+1/2I_{R}Ω².

The ideal flare entry kinetic energy is the kinetic energy calculated using the desired steady state forward speed (for v) and the desired steady state rotor speed (for Ω):

KE_{ideal}=1/2m u_{min descent rate}²+1/2I_{R}Ω_{ss,desired}².

A constraint on TTLE based on the ratio of KE to KE_{ideal} is introduced in the control law to inhibit the helicopter from flaring too early. This rule enforces the following constraint:

$$TTLE \leq ( \frac{KE}{{KE}_{ideal}} ) {TTLE}_{max} .$$

This constraint is illustrated in operations (680, 685, 686, 687, 688), which take the ratio of KE to KE_{ideal} (limited to a maximum value of 1) and multiplies it by the values of TTLE computed from the horizontal and vertical velocity and acceleration values. This energy-constrained TTLE is then multiplied by the fuzzy set-checked values in (691, 692). The output of the energy constrained TTLE can be provided to the sign constrained values (685, 686, 687, 688) to then multiply (691, 692) with the fuzzy set checked values. A maximum energy-constrained TTLE (693) can then be determined.

An alternative implementation is to calculate TTLE according to the amount of kinetic energy that the helicopter has available to perform maneuvers. If the rotor is spinning rapidly, and the helicopter has significant forward speed, the descent can be more gradual, and TTLE is larger. Conversely, if there is little available kinetic energy, the helicopter must flare later and more drastically, and TTLE is smaller. Thus TTLE can be scaled between 0 and TTI_F_MAX−TTI_L according to the kinetic energy available for maneuver, which is defined as the sum of the kinetic energy due to horizontal velocity and the rotor rotational energy. First, the ideal total kinetic energies at flare entry and exit are calculated according to,

KE_{flare entry}=1/2m(U_AUTO)²+1/2I_{R}(RPM_AUTO)²

KE_{flare exit}=1/2M(U_TOUCHDOWN)²+1/2I_{R}(RPM_AUTO)².

Then, the total kinetic energy of the helicopter at the current time is computed as,

KE_{available}=1/2mu²+1/2I_{R}Ω².

Given the ideal and actual kinetic energy values, a scale factor between 0 and 1 may be generated describing the remaining kinetic energy in comparison with the desired values,

$${SF}_{TTLE} = \frac{{KE}_{available} - {KE}_{flare exit}}{{KE}_{flare entry} - {KE}_{flare exit }} .$$

Finally, TTLE is calculated according to,

TTLE=TTLEₘₐₓ min(1,max(0,SF_{TTLE}))

where

TTLEₘₐₓ=(TTI_F_MAX−TTI_L).

The remaining task (task B) of the flare phase of the autorotation controller is to determine a control value such that the helicopter will enter the landing phase approximately TTLE seconds from the current time. Here, a vertical trajectory can be generated and tracked. Let TTI_{F} be defined as the desired time to impact given that it takes approximately TTI_{L} seconds to progress through the landing phase (and also illustrated as 650 in FIG. 6A):

TTI_{F}≡TTI_{L}+TTLE.

If the helicopter is modeled as a point mass and attains a vertical acceleration \ddot{h}(t) at time t and maintains that constant acceleration, the altitude, h, at time t+TTI_{F} will be

h(t+TTI_{F})=h(t)+\dot{h}(t)TTI_{F}+1/2\ddot{h}(t)TTI_{F}².

This can be solved for h(t+TTI_{F})=0 to yield an expression for \ddot{h}_{desired} that, if maintained, will cause the helicopter to impact the ground at time t+TTI_{F}:

$${\ddot{h}}_{desired} = - \frac{2}{{TTI}_{F}^{2}} h - \frac{2}{{TTI}_{F}} \dot{h} , when {TTI}_{F} \leq - \frac{2 h}{\dot{h}} .$$

If

$${TTI}_{F} > - \frac{2 h}{\dot{h}} ,$$

then the helicopter would impact the ground in less than TTI_{F}. Therefore, according to an implementation, the controller (while operating in the flare phase) commands a large upward adjustment of the collective pitch in the event the condition

$${TTI}_{F} > - \frac{2 h}{\dot{h}}$$

is met. The rate of adjustment is specific to the rotorcraft. The rapid adjustment can be an adjustment rate that increases linearly or exponentially above a threshold (a user-defined value or curve) to try to slow down the descent rate if it looks like the helicopter will not slow down in time. The difference in rate of adjustment under this condition compared to the rates of adjustment outside of this condition can be considered to be above a user defined threshold. This is analogous to a human pilot rapidly increasing the collective pitch when he or she realizes the vertical velocity is too large until the velocity has reached a manageable value.

The value of the collective pitch corresponding to \ddot{h}_{desired} is unknown and highly dependent upon the physical states of the helicopter such as the inflow and proximity to the ground. However, approximations can be used in various implementations while still providing suitable results.

One implementation of the flare control law involves a simple approximation:

$$\ddot{h} = \frac{{θ}_{0}}{{K}_{{θ}_{0}}} .$$

In order to drive towards the value required to produce \ddot{h}_{desired}, the following control law can be adopted.

$${\dot{θ}}_{0} = \frac{{K}_{{θ}_{0}}}{τ} ( {\ddot{h}}_{desired} - \ddot{h} ) .$$

This control law drives the system output toward the desired descent acceleration. In this implementation, K_{θ0} and τ are redundant controller parameters, but both are very useful for understanding the system and tuning the controller.

Accordingly, the control law for the flare phase of one implementation can be expressed as

$${\dot{θ}}_{0} = \{ \begin{matrix}\frac{{K}_{{θ}_{0}}}{τ} ( - \frac{2 ( h + \dot{h} {TTI}_{F} )}{{TTI}_{F}^{2}} - \ddot{h} ) & if {TTI}_{P} \leq - \frac{2 h}{\dot{h}} \\ {\dot{θ}}_{{0}_{fast}} & else\end{matrix} \\ {u}_{desired} = {u}_{td} \\ {θ}_{ma x} = limited only by horizontal controller .$$

### Landing

In the landing phase, the controller seeks to bring the helicopter to the ground gently with an attitude near level. The control law is similar to the flare phase control law, except that the desired time to impact remains constant.

$${u}_{desired} = {u}_{td}$$

$${θ}_{ma x} = Landing {θ}_{ma x}$$

$${\dot{θ}}_{0} = \{ \begin{matrix}\frac{{K}_{{θ}_{0}}}{τ} ( - \frac{2 ( h + \dot{h} {TTI}_{F} )}{{TTI}_{F}^{2}} - \ddot{h} ) & if {TTI}_{P} \leq - \frac{2 h}{\dot{h}} \\ {\dot{θ}}_{{0}_{fast}} & else\end{matrix} .$$

### Touchdown

The touchdown phase brings the helicopter to rest on the ground by decreasing the collective slowly and attempting to maintain a level orientation. The following equations describe control parameters during this phase:

u_{desired}=u_{td}

θₘₐₓ=Touchdown θₘₐₓ

\dot{θ}₀=\dot{θ}_{0td}.

Although not included in the relationship shown above, for large manned helicopters, limits on the control inputs can be implemented in this phase to keep the blades from impacting the empennage after touchdown due to the very low rotational rate of the rotor. Control input limits are dependent on the vehicle under consideration.

A greater understanding of the present invention and of its many advantages may be obtained from the following examples, given by way of illustration. The following examples are illustrative of some of the methods, applications, embodiments and variants of the present invention. They are, of course, not to be considered in any way limitative of the invention. Numerous changes and modifications can be made with respect to the invention and will fall within the spirit and purview of the claims.

### Simulation Model

A high-fidelity six-degree-of-freedom helicopter simulation model was created in order to validate the control laws described above. Empennage, horizontal stabilizer, vertical stabilizer, and tail rotor forces and moments are computed based on the ARMCOP model described by Talbot et al. in “A Mathematical Model of a Single Main Rotor Helicopter for Piloted Simulation” (NASA TM-84281, 1982), which is incorporated by reference herein in its entirety. The main rotor model, however, provides higher fidelity than that used in ARMCOP, incorporating dynamic blade flapping, dynamic inflow, ground effect, and blade stall.

### A. Tail Rotor, Fuselage, Empennage, Stabilizers

The tail rotor, fuselage, empennage, and stabilizers were implemented in the simulation as described by Talbot et al. The tail rotor uses Newton-Raphson iteration to calculate uniform tail rotor inflow. Other components have rudimentary aerodynamic models which introduce body-frame forces and moments affecting the motion of the helicopter.

### B. Forces and Moments Generated by the Main Rotor

The forces and moments generated by the main rotor were calculated using a numerical blade element approach. In this approach, the main rotor blade is divided into 15 blade elements and 2D aerodynamic analysis is performed. The velocity of the air due to the motion of the helicopter and the induced inflow is calculated at each blade element. Based on this velocity, the forces on the blade element are calculated using a lift and drag coefficient look up table for the specific airfoil under consideration. The use of this lookup table implicitly incorporates rudimentary blade stall effects. This calculation for a representative blade is carried out at 30 rotational stations evenly distributed over a complete revolution. The results are summed and appropriately normalized according to the number of blades and rotation stations. This numerical calculation is used to obtain the aerodynamic forces exerted by the entire rotor and combined with inertial reaction forces to determine total rotor forces and moments. Blade loads determined by these calculations are also used to determine the rotor rotation rate derivative \dot{Ω} when the engine is not powering the vehicle through computation of main rotor torque. In addition to the forces and moments exerted on the helicopter, these calculations determine the aerodynamic force and moment coefficients needed in the dynamic inflow model.

### C. Blade Flapping

First harmonic flapping is assumed and higher-harmonic flapping dynamics are neglected for the control law studies. First harmonic blade flapping states β₀, β₁ₛ, and β_{1c} and their time derivatives are integrated into the model as states. The differential equation that governs flapping is given by,

\ddot{β}+ω_{N}²β=M_{F}

where M_{F} includes all aerodynamic loads calculated through blade element theory and inertial moments as outlined by Talbot et al. and

$${ω}_{N} = Ω \sqrt{\frac{{I}_{B} + \frac{meR}{2 }}{{I}_{B}}}$$

where m is the blade mass, R is the blade radius, e is the flap hinge offset, and I_{B} represents the blade flap-wise inertia. The flapping differential equation is solved using a harmonic balancing approach in which a first-harmonic solution is assumed and harmonic coefficients β₀, β₁ₛ, and β_{1c} are extracted through the following projection operation:

∫₀^{2π}(\ddot{β}+ω_{N}²β−M_{F})dψ_{MR}=0

∫₀^{2π}(\ddot{β}+ω_{N}²β−M_{F})cos ψ_{MR}dψ_{MR}=0

∫₀^{2π}(\ddot{β}+ω_{N}²β−M_{F})sin ψ_{MR}dψ_{MR}=0.

Solution of the above integral equations yields second order differential equations for each of the three flapping states β₀, β₁ₛ, and β_{1c}.

### D. Dynamic Inflow

The dynamic inflow model used here is described by Peters et al., “Dynamic Inflow for Practical Applications,” Journal of the American Helicopter Society, October, 1988 pp. 64-68, which is incorporated by reference in its entirety. The model has three states, λ₀, λₛ, and λ_{c} which describe an induced inflow ratio distribution over the rotor disk according to the equation

$$[ M ] [ \begin{matrix}{\dot{λ}}_{0} \\ {\dot{λ}}_{s} \\ {\dot{λ}}_{c}\end{matrix} ] + {[ \hat{L} ]}^{- 1} [ \begin{matrix}{λ}_{0} \\ {λ}_{s} \\ {λ}_{c}\end{matrix} ] = C$$

These states evolve according to the dynamic equation

$${λ}_{i} ( r , ψ ) = {λ}_{0} + {λ}_{s} \frac{r}{R} sin ( ψ ) + {λ}_{c} \frac{r}{R} cos ( ψ ) .$$

where C is a vector of force and moment coefficients calculated using the blade element approach described above, [\hat{L}] is a matrix dependent on the sideslip angle and wake angle, and [M] is a mass term based on the mass of air near the rotor. Additional details regarding this model can be found in “Dynamic Inflow for Practical Applications,” by Peters et al.

### E. Ground Effect

A simple ground effect correction is applied to the dynamic inflow model when the rotor is near the ground. Equation (22) shows that when the inflow has reached a steady state (i.e., \dot{λ}=0),

C=[\hat{L}]⁻¹λₛₛ

where λₛₛ is the vector of the inflow states at steady state. It can be assumed that in ground effect the steady state inflow can be modeled by

$${λ}_{ssIGE} = ( 1 - \frac{Δ w}{{w}_{0}} ) {λ}_{ss}$$

where Δw/w₀ is a correction term for ground effect in forward flight described by Heyson et al., “Ground Effect for Lifting Rotors in Forward Flight,” NASA Technical Note D-234, 1960. This is applied in the dynamic inflow model by adjusting C so that λ tends towards λ_{ssIGE}. At steady state,

$$\begin{matrix}\begin{matrix}{C}_{IGE} = {[ \hat{L} ]}^{- 1} {λ}_{ssIGE} \\ = {[ \hat{L} ]}^{- 1} ( 1 - \frac{Δ w}{{w}_{0}} ) {λ}_{ss} \\ = {[ \hat{L} ]}^{- 1} [ \hat{L} ] ( 1 - \frac{Δ w}{{w}_{0}} ) C\end{matrix} & \\ {C}_{IGE} = ( 1 - \frac{Δ w}{{w}_{0}} ) C . & \end{matrix}$$

C_{IGE} can be used to adjust C when the main rotor is within two rotor diameters of the ground. The values for Δw/w₀ were taken from a lookup table based on FIG. 2 of “Ground Effect for Lifting Rotors in Forward Flight,” Heyson, H. H., NASA Technical Note D-234, 1960, which is incorporated by reference in its entirety. The data is indexed based on the height above ground and the wake angle determined from the inflow state and the velocity of the helicopter.

### F. Actuators

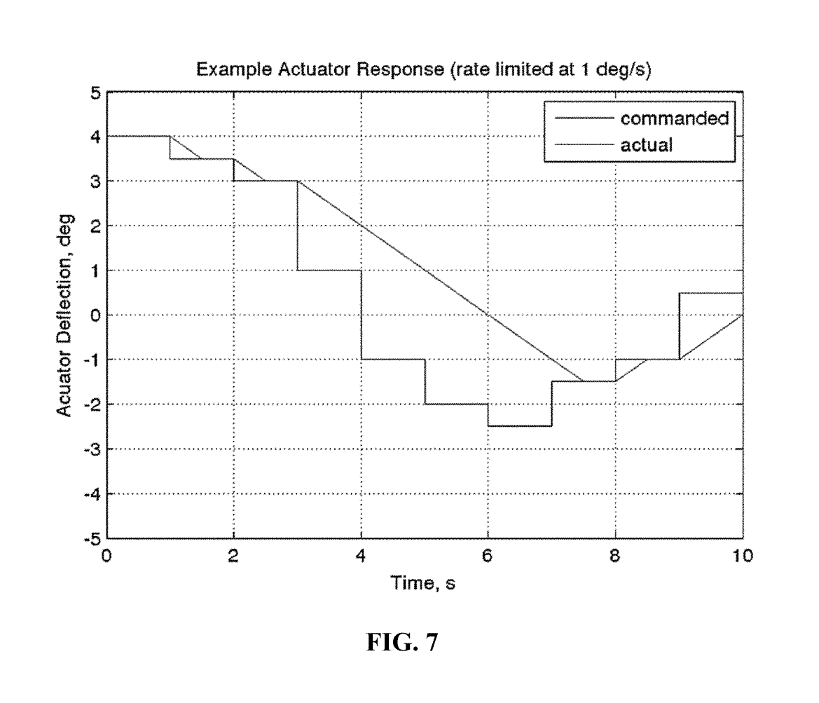

The simulated control actuators are limited to a maximum rate and have maximum and minimum stops. Therefore, the actual control value differs from the commanded control value depending on how fast changes are applied. The behavior for a control input updated at 1 Hz and an actuator limited to 1°/s response is illustrated in FIG. 7. As can be seen in FIG. 7, the actuator responds as quickly as possible without exceeding a specified rate.

For the simulations presented here, a simple multi-layered PID controller was implemented for velocity and yaw angle tracking through the θ₁ₛ, θ_{1c}, and θₜᵣ control channels.

The simulation models each control (θ₀, θ₁ₛ, θ_{1c}, and θ_{TR}) as if each control had its own dedicated actuator, so the complex rate and limit interactions between the actuators connected to the swash plate are not modeled. These controls are vehicle-specific, but in general actuator lag is included in the model through this rate-limiting scheme.

### IV. Simulation Results

### Bell AH-1G Cobra Attack Helicopter

A large number of Monte-Carlo simulations were run to provide preliminary validation of the controller. The model used in these tests is based on the Bell AH-1G Cobra attack helicopter. Most of the model parameters were obtained from Talbot et al.

Table 3 lists some of the important model parameters pertaining to autorotation for the Bell AH-1G Model; Table 4 lists the controller parameters used for these tests.

TABLE 3

| Parameter | Symbol | Value | |
|---|---|---|---|
| Helicopter gross weight | W | 8300 | lb. |
| Number of main rotor blades | N_{b} | 2 (Teetering) | |
| Main rotor blade chord | c | 2.25 | ft |
| Main rotor radius | R | 22 | ft |
| Main rotor blade moment of inertia | I_{B} | 2770 | slug ft² |
| Main rotor height above ground (water line) | WL_MR | 12.73 | ft |
| Main rotor normal operating speed | Ωₙₒᵣₘₐₗ | 32.88 | rad/s |
| Main rotor blade airfoil used for simulation | | NACA 0012 | |
| Actuator max rate | \dot{θ}_{actuator max} | 40 | deg/s |
| Controller update rate | | 20 | Hz |

TABLE 4

| | | Value in AH-1 | |
|---|---|---|---|
| Parameter | Description | Controller | |
| u_{min descent rate} | Forward speed for minimum descent | 100 | ft/s |
| | rate (near the recommended speed for | | |
| | autorotation for the helicopter) | | |
| K_{DSS} | Gain on rotor speed time derivative | 0.03 | |
| | for collective control during steady- | | |
| | state descent | | |
| K_{PSS} | Gain on rotor speed for collective | 0.01 | |
| | control during steady-state descent | | |
| Pre-Flare θₘₐₓ | Maximum cap on roll and pitch angle | 10° | |
| | during the Pre-Flare phase | | |
| K_{θ}_{₀} | Rotor collective gain for Flare and | 6 × 10⁻⁴ | |
| | Landing phases | | |
| τ | Rotor collective adjustment time | 0.05 | s |
| | constant tuning parameter for Flare | | |
| | and Landing phases | | |
| \check{θ}₀_{_{fast}} | Collective adjustment rate for rapid | 15°/s | |
| | adjustments during the Flare and | | |
| | Landing phase | | |
| TTLEₘₐₓ | Maximum cap on the desired time to | 3.5 | s |
| | Landing entry during the Flare phase | | |
| TTI_{L} | Desired time to impact during the | 1.5 | s |
| | Landing phase | | |
| Landing θₘₐₓ | Maximum cap on roll and pitch | 8° | |
| | angles during the Landing phase | | |
| \check{θ}₀_{_{td}} | Constant collective pitch rate during | −1°/s | |
| | Touchdown phase | | |
| u_{td} | Desired forward velocity at touch- | 10 | ft/s |
| | down | | |

| | | |
|---|---|---|
| Touchdown θₘₐₓ | Maximum cap on roll and pitch | 1° |
| | angles during the Touchdown phase | |

The approach used to determine the parameters for the AH-1G yielded usable values with minimal effort. First K_{θ0} was determined (or at least the order of magnitude was fixed) using

$${TTI}_{F} > - \frac{2 h}{\dot{h}} ,$$

along with some crude blade element theory calculations. Then the speed of the response was adjusted by changing τ. For the controller parameters shown in Table 4, “round” values were selected for the AH-1; none have more than two significant figures. This is because these parameters are approximate and do not require precise tuning for good performance.

The values of the transition points of the control phases of Steady State Descent, Pre-Flare, Landing, and Touchdown for the Bell AH-1G Cobra are given in Table 5. There is an “OR” relationship between the altitude and time to impact phase definitions; i.e., the controller will begin to advance to the flare phase if it is below the flare upper boundary altitude or if the predicted time to impact is less than the upper boundary time to impact. Also, the controller is implemented so that it progresses through the phases sequentially; i.e., once the controller is in the flare phase, it cannot return to the pre-flare phase, even if the altitude increases. This means that there is not necessarily a unique mapping from the physical state of the helicopter at a given time to a control output. Instead, the control output also depends on the internal controller state or equivalently the time history of the helicopter physical state. In the following subsections, the control laws for each phase are described.

TABLE 5

| Transition | Altitude Range (ft) | Time to Impact Range (s) |
|---|---|---|
| Steady State Descent | 100 to 150 | 5 to 7 |
| to Pre-Flare | | |
| Pre-Flare to Flare | 20 to 50 | 3 to 3.5 |
| Flare to Landing | 3 to 12 | 0.5 to 1.2 |
| Landing to Touchdown | 0 to 2 | 0 to 0.1 |

As shown in Table 5 providing the regions for flight phase fuzzy transitions, since trapezoidal membership functions are used, transitions are linear.

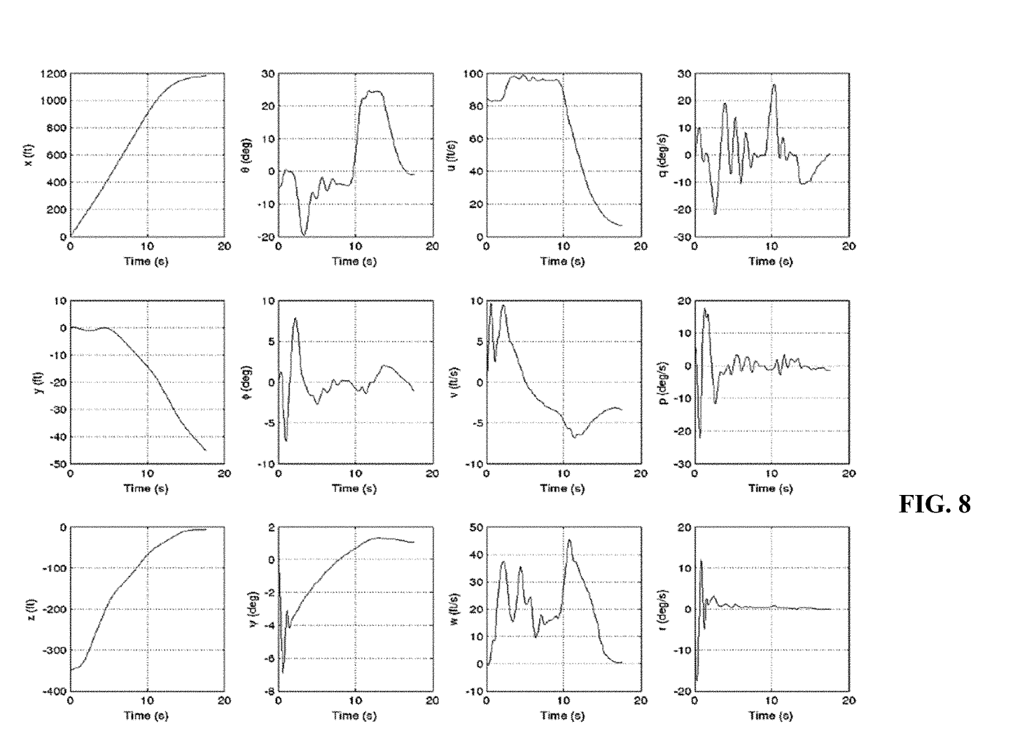

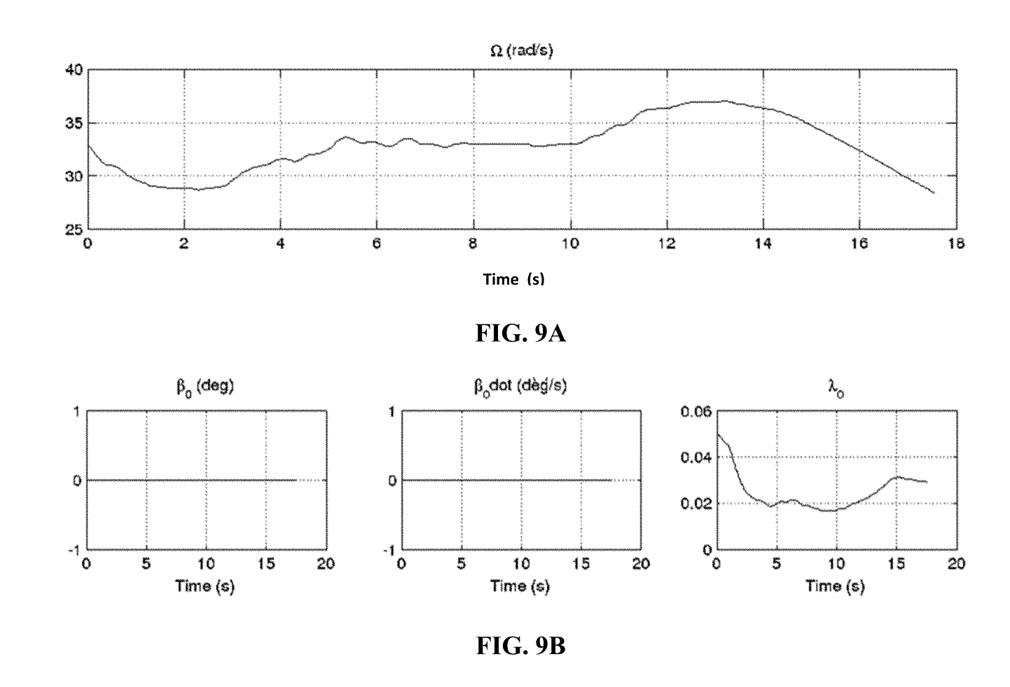

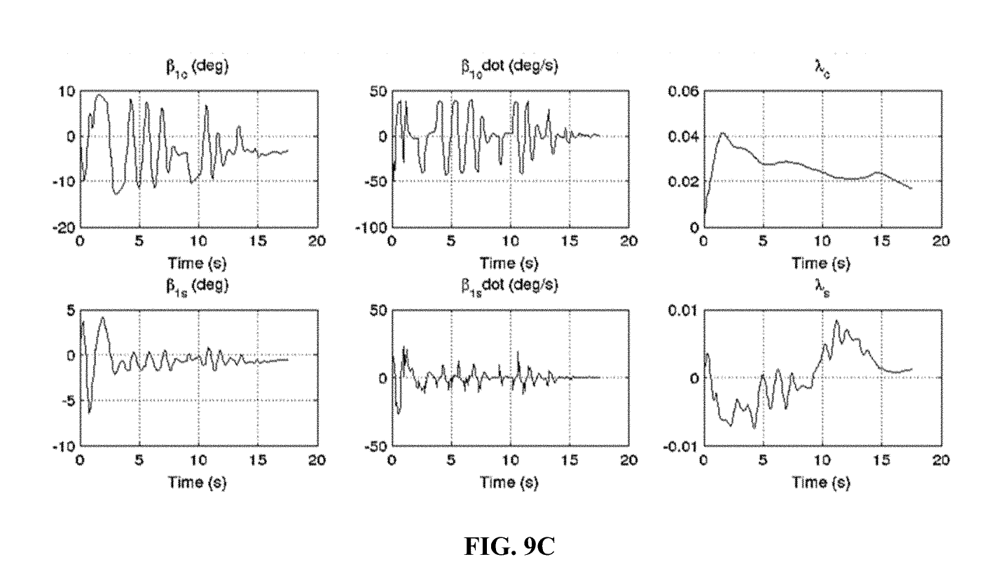

FIGS. 8 and 9A-9C show the time histories of the physical states of a helicopter performing an autorotation descent from an altitude of 350 ft and a forward speed of 50 knots. This initial state is near the edge of the “avoid” region of the H-V diagram, but the controller handles the maneuver well, bringing the vehicle to a safe landing. A one second delay between engine shutoff and the point at which the autorotation controller takes over from the normal flight controller is simulated, representing the actual time it would take to confirm power loss and initiate the autorotation controller.

There are a variety of notable features in these plots. First, note the immediate drop in rotor rotation rate Ω before the autorotation controller takes effect followed by the return of Ω to a value slightly higher than the normal operating value during steady state descent. Next, note that u achieves the desired forward speed for minimum descent rate, given as 100 ft/s for this helicopter. Also note the decrease in the induced velocity (λ₀) as the helicopter approaches the ground due to ground effect. Finally, note that at landing all velocities and orientation angles are small indicating a safe touchdown.

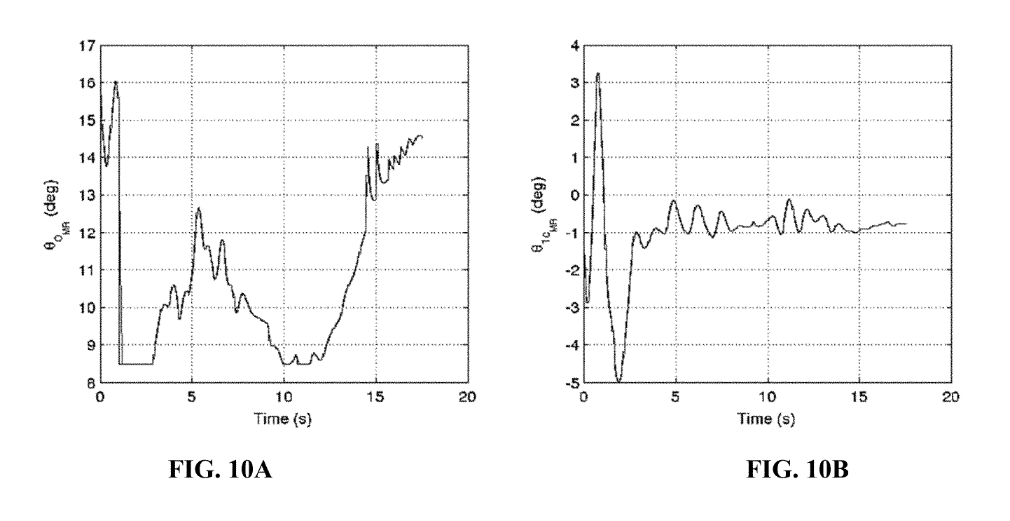

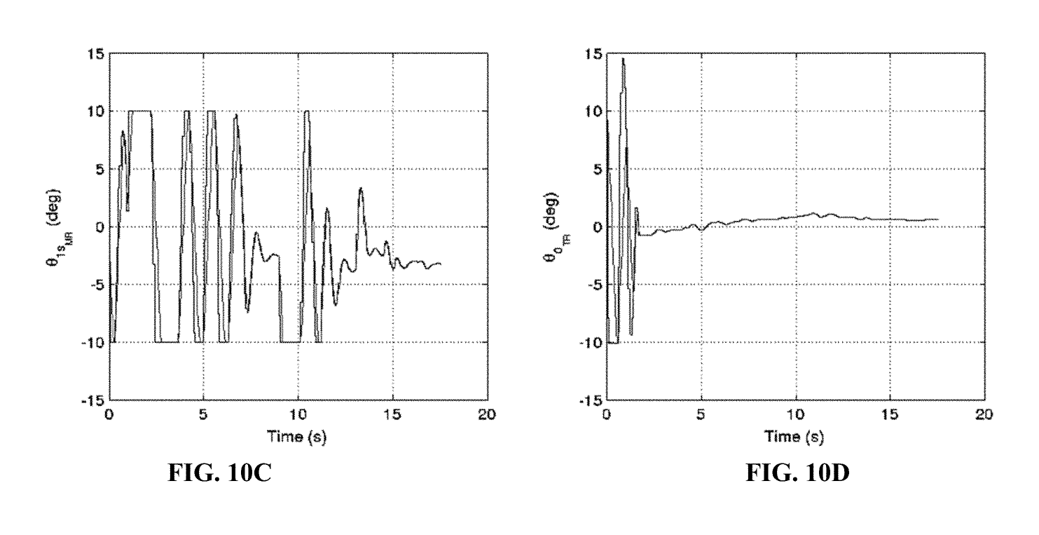

FIGS. 10-12 show plots indicating controller internal states and outputs. FIGS. 10A-10D show the control outputs for the sample autorotation. The large control oscillations in the θ₁ₛ history indicate that the PID controller used as the velocity tracking controller in this example is likely not optimally tuned. A more advanced control architecture used for the velocity tracking controller would likely command less drastic cyclic pitch values. Note the sharp peaks in θ₀ near the end of the dataset. These peaks indicate violations of the

$${TTI}_{F} \leq - \frac{2 h}{\dot{h}}$$

condition in the control law. When this occurs, the controller rapidly increases θ₀. Though these peaks appear dramatic, the amplitude is less than 2° for the largest, and the frequency is not more than 2 Hz.

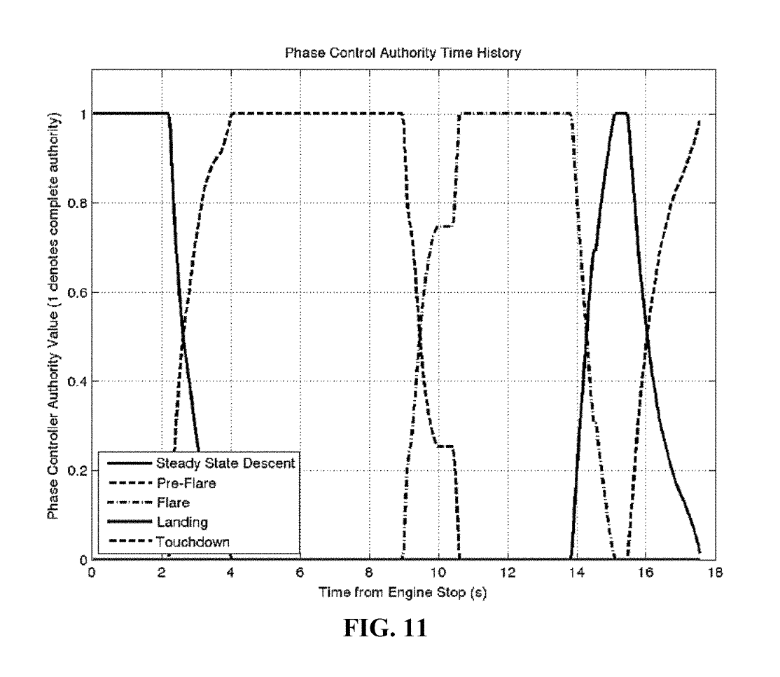

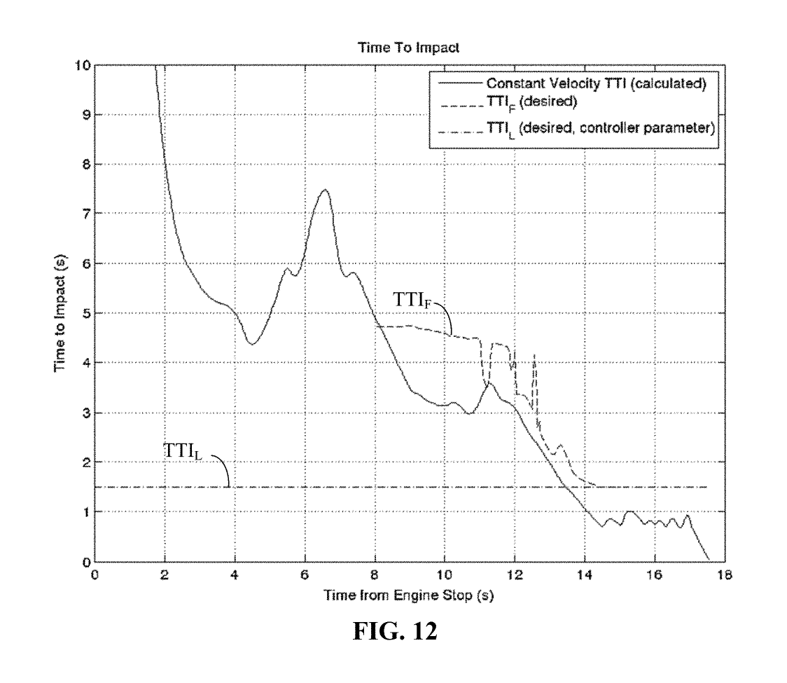

In FIGS. 10A-10D, there are two lines plotted for each of the control histories. The line that leads is the commanded control position; the line that lags slightly at some points is the actual actuator position. FIG. 11 shows which phase controllers have authority (are active) during different portions of the landing. The plot shown in FIG. 12 shows the values of the Time to Impact domain variables during the simulation and provides the values of several internal controller states, calculated constant velocity TTI, desired TTI_{F} and desired controller parameter TTI_{L}. Note that TTLE can be read off the plot as the difference between TTI_{F} and TTI_{L}.

As shown in FIG. 12, TTI_{\dot{h}=0} stays below TTI_{F} and TTI_{L} because TTI_{L} and TTI_{F} include acceleration while TTI_{\ddot{h}=0} does not. When the desired values TTI_{F} and TTI_{L} are relatively constant, the measured value TTI_{\ddot{h}=0} also remains relatively constant, indicating that the collective control law is successfully influencing TTI_{\ddot{h}=0} based on the values of TTI_{F} and TTI_{L}.

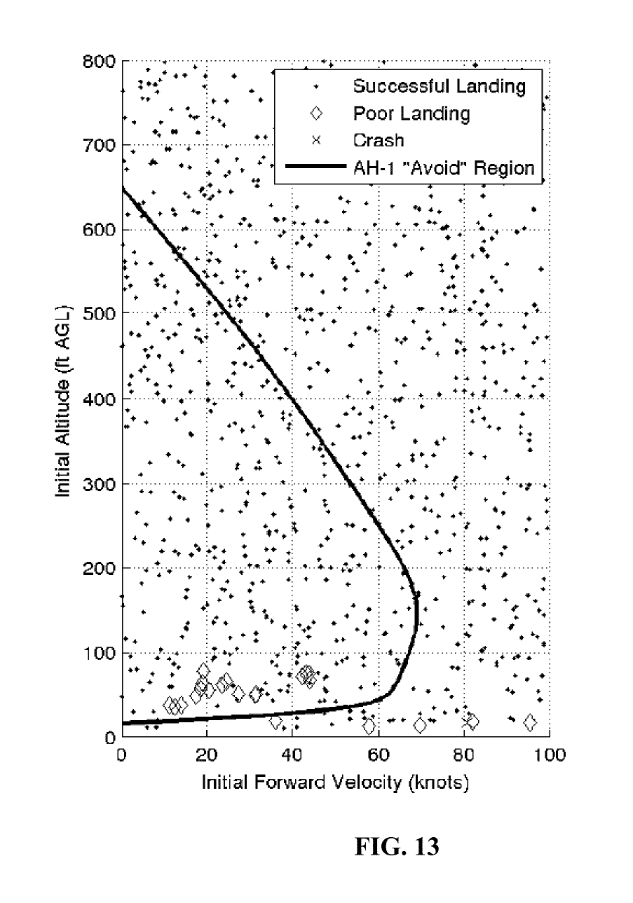

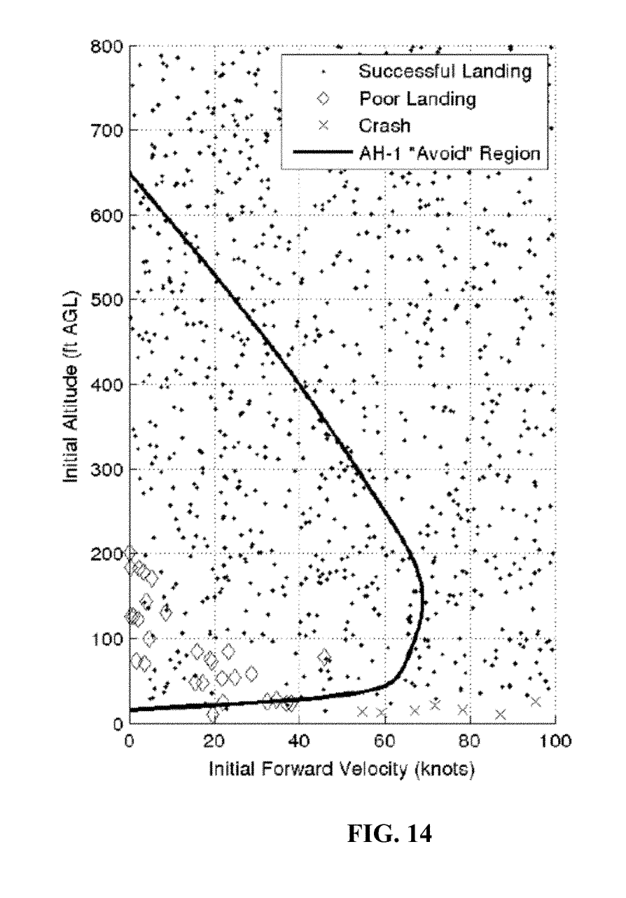

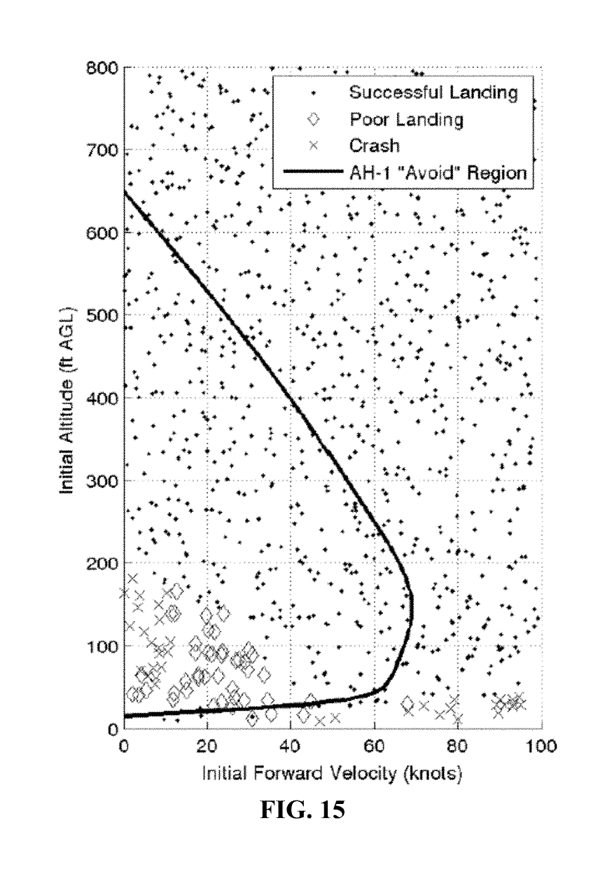

Monte Carlo simulations were conducted in and around the “avoid” region of the H-V diagram to demonstrate that the controller is able to recover from difficult initial conditions and significantly increase the envelope of safe flight. One relevant factor in determining the likelihood of a successful autorotation is the time between engine, transmission, or tail rotor failure and the beginning of autorotation-friendly maneuvers by the pilot or control system. In an emergency, even an autonomous system might require some time to detect the failure and hand off control to the autorotation control law. Human pilots are typically expected to react to an emergency in 1-2 seconds depending on pilot workload, so simulations are conducted assuming immediate handoff (FIG. 13), a handoff delayed by 1 second (FIG. 14), and a handoff delayed by 2 seconds (FIG. 15).

FIG. 13 shows the results of 1000 simulated autorotation landings with an immediate handoff. Each solid dot represents a successful landing from the indicated position. A diamond indicates a landing that would likely result in damage to the vehicle, but equipment or passengers would not be in serious danger. An x indicates a crash. The specific thresholds for each of these categories are listed in Table 6. The low-speed “avoid” region of the H-V diagram for the Cobra helicopter is also marked. This curve is taken from Free et al., “Height-Velocity Test—AH-1G Helicopter at Heavy Gross Weight,” U.S. Army Aviation Systems Test Activity, 1974, which is incorporated by reference in its entirety. Note that the controller is able to perform a safe autorotation in nearly all cases, although some landings are not ideal. FIG. 14 shows the results of 1000 simulated autorotations with a handoff delayed by 1 second, and FIG. 15 shows the results for a handoff delayed by 2 seconds.

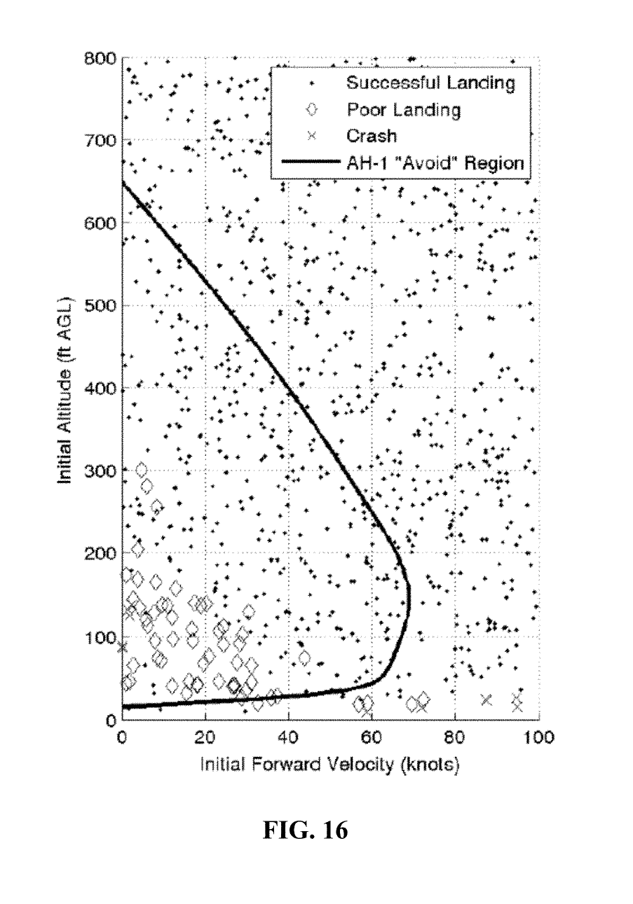

It is also likely that the controller will be asked to perform an autorotation when the vehicle is overweight, a condition in which autorotation performance is degraded by the increase in disk loading. FIG. 16 shows the results of 1000 simulated autorotations for an AH-1G with weight increased to 9000 lb with a handoff delay of 1 second. The control law and all of its parameters are identical to those used in previous tests.

In all tests, the controller generally has difficulty at low altitudes and high speeds. This is a typically avoided region of the H-V envelope because of the difficulty of autorotation here. Overall, the Monte Carlo simulations presented here clearly demonstrate that the new control law holds the potential significantly expand the safe H-V envelope when compared to a human pilot.

TABLE 6

| | Condition for | Condition for |
|---|---|---|
| Parameter | Good Landing | Poor Landing |
| Roll angle, Φ | <10° | <20° |
| Pitch angle, θ | <12° | <20° |
| Forward Speed, \check{x} | <50 ft/s (30 knots) | <76 ft/s (45 knots) |
| Lateral Speed, ŷ | <7 ft/s | <10 ft/s |
| Vertical Speed, z̊ | <5 ft/s | <12 ft/s |
| Roll Rate, p | <20°/s | <40°/s |
| Pitch Rate, q | −30°/s < q < 20°/s | −50°/s < q < 40°/s |
| Yaw rate, r | <20°/s | <40°/s |

In Table 6, simulations that do not meet the criteria for a good or poor landing are considered crashes. Conditions are applied to the absolute value of the parameter unless otherwise noted.

### Align T-REX 600 Hobby-Class Helicopter

The controller has also been applied to a model of the Align T-REX 600 hobby-class helicopter to demonstrate its scalability. The controller was exercised on a lower-fidelity helicopter model of the T-REX 600. This model is a 6-degree-of-freedom ARMCOP-based simulation that does not include dynamic inflow, ground effect, or blade stall. The main rotor in this model uses a uniform inflow assumption and combined blade element-momentum theory to compute blade loads. Flapping is assumed to be quasi-static rather than fully dynamic. This simplified model has been compared extensively to the more complex model described above and shows reasonable correlation outside ground effect for most maneuvers. Furthermore, ground effect actually enhances controller operation, so testing without the benefit of ground effect actually represents a worst-case scenario.

Model and controller parameters are shown in Tables 7 and 8. Note that his helicopter has a semi-rigid rotor system, which differs significantly from the teetering AH-1G hub.

TABLE 7

| Parameter | Value in TREX 600 Controller | |
|---|---|---|
| u_{min descent rate} | 32.8 | ft/s |
| K_{DSS} | 0.003 | |
| K_{PSS} | 0.007 | |
| Pre-Flare θₘₐₓ | 10° | |
| K_{θ}_{₀} | 3.1 × 10⁻⁴ | |
| τ | 0.01 | s |
| \check{θ}₀_{_{fast}} | 15°/s | |
| TTLEₘₐₓ | 7.0 | s |
| TTI_{L} | 1.0 | s |
| Landing θmax | 10° | |
| \check{θ}₀_{_{td}} | −1 | ft/s |
| u_{td} | 1 | ft/s |

| | |
|---|---|
| Touchdown max | 3° |

TABLE 8

| Parameter | Value | |
|---|---|---|
| W | 8.15 | lb |
| Nb | 2 | |
| C | 0.177 | ft |
| R | 2.208 | ft |
| IB | 0.02714 | slug ft² |
| WL_MR | 1.5 | ft |
| Ωₙₒᵣₘₐₗ | 170 | rad/s |
| Main Rotor Blade Lift Curve Slope | 5.0 | rad⁻¹ |
| \check{θ}_{actuator max} | 100 | deg/s |
| Controller Update Rate | 20 | z |

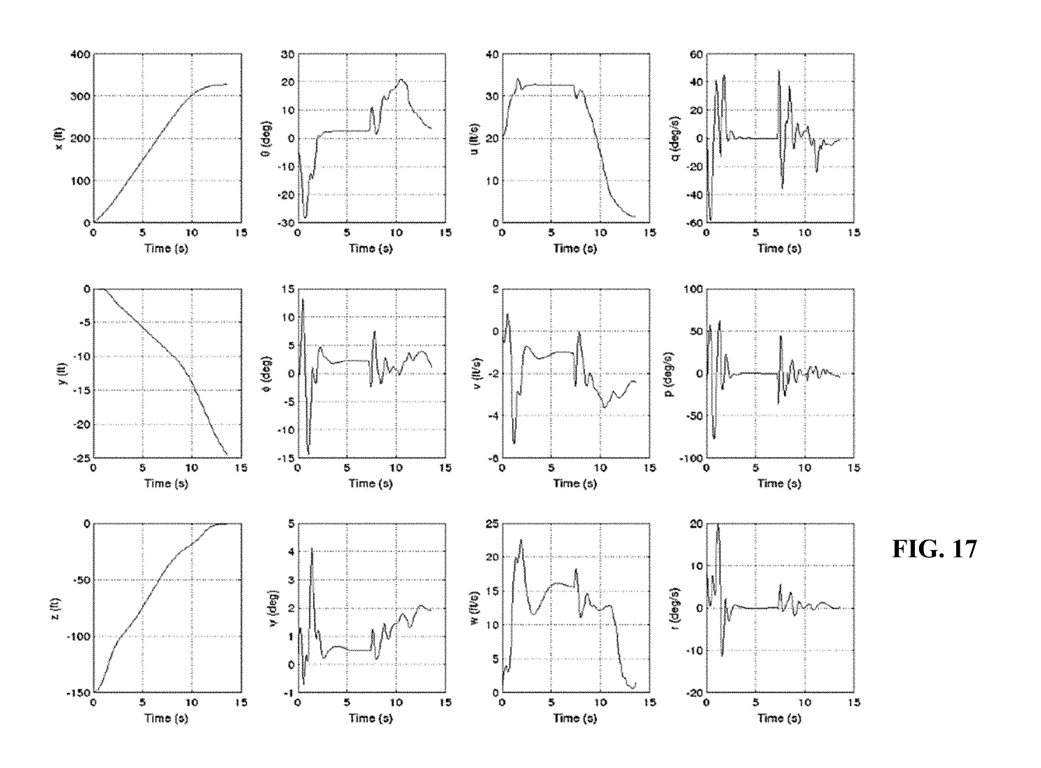

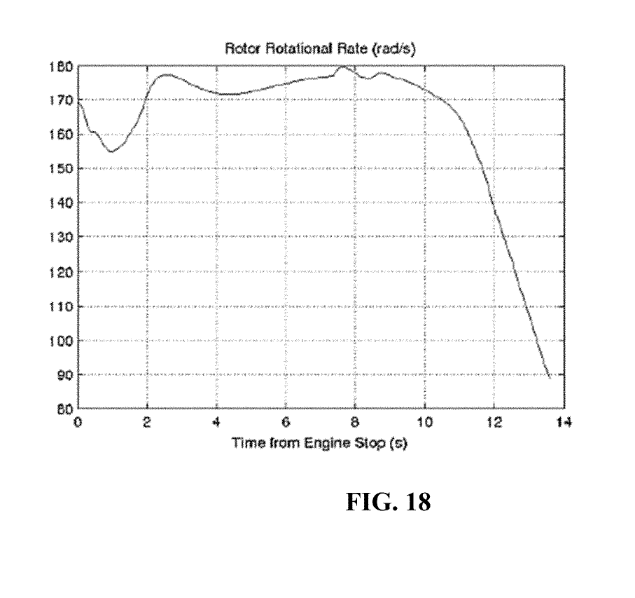

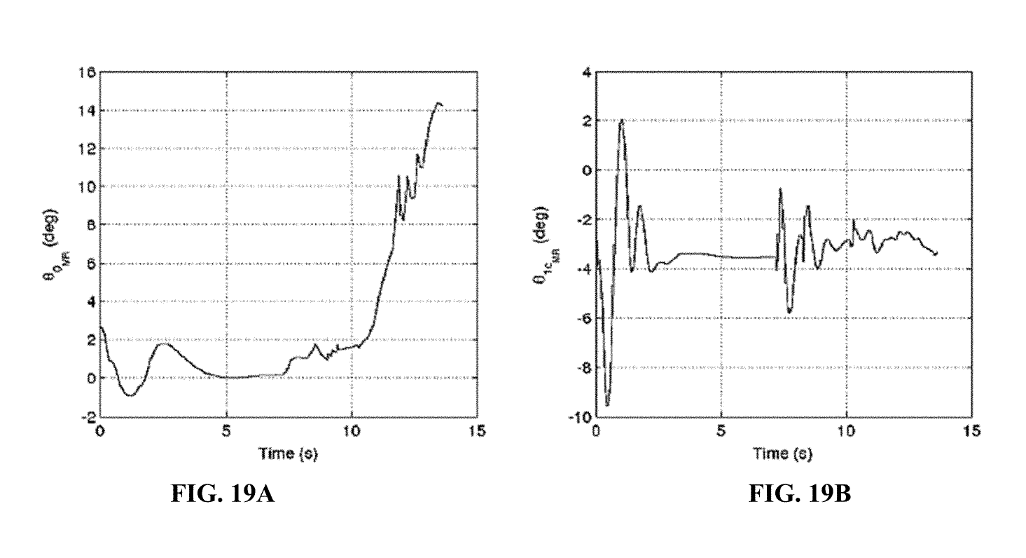

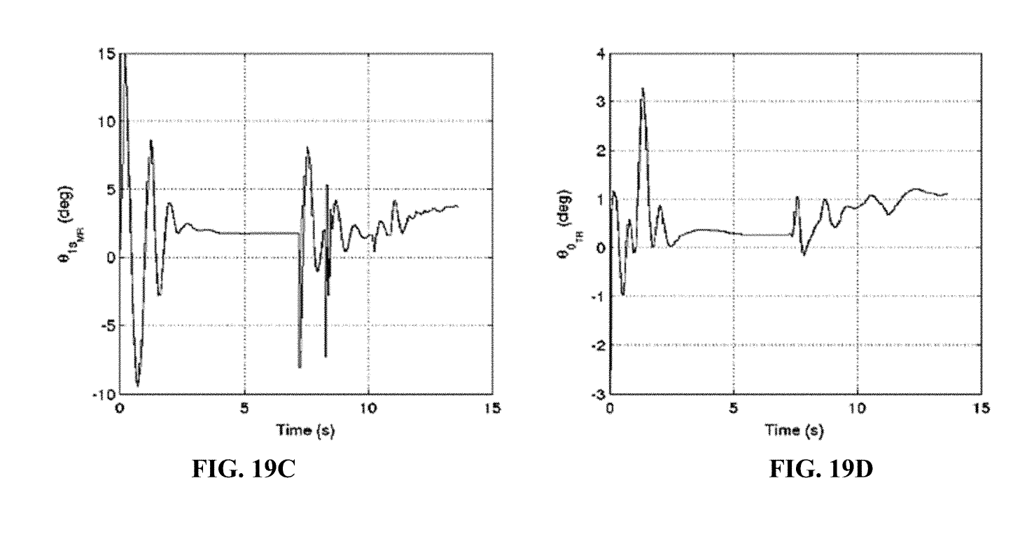

FIGS. 17-19 show the state and control histories of a sample autorotation for the small helicopter. This simulation shows similar performance in many ways to the simulations of the larger helicopter.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. In no case do “computer-readable storage media” consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Example scenarios have been presented to provide a greater understanding of certain embodiments of the present invention and of its many advantages. The example scenarios described herein are simply meant to be illustrative of some of the applications and variants for embodiments of the invention. They are, of course, not to be considered in any way limitative of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A computer-readable storage medium having instructions stored thereon, that when executed by an autorotation controller causes the autorotation controller to perform a method comprising:
calculating a predicted time to ground impact;
determining descent phase using the predicted time to ground impact; and
adjusting a desired trajectory for controlling autorotation descent according to the descent phase.

2. The medium of claim 1, wherein the instructions for adjusting the desired trajectory for controlling autorotation according to the descent phase comprises instructions for:
in response to a determination of a flare descent phase for a rotorcraft, determining a prescribed desired time to impact and outputting a rotor pitch control for the desired time to impact.

3. The medium of claim 2, wherein the prescribed desired time to impact is determined using a kinetic energy measure.

4. The medium of claim 2, wherein the instructions for adjusting the desired trajectory for controlling autorotation according to the descent phase further comprises instructions for:
in response to a value of the desired time to impact being less than −2h/\dot{h} where h is an altitude value received by the autorotation controller and \dot{h} is a vertical velocity value received by the autorotation controller, outputting a rotor pitch control with an adjustment rate above a threshold.

5. The medium of claim 1, wherein the instructions for adjusting the desired trajectory for controlling autorotation according to the descent phase comprises instructions for:
in response to a determination of a steady state descent phase, outputting a rotor pitch control for maintaining a constant rotor rotation rate with a trajectory at a minimum descent rate; and
in response to a determination of a touchdown phase, outputting a constant rotor pitch control.

6. An autorotation controller configured to adjust a desired trajectory based on a predicted time to ground impact value continuously calculated in response to a failure event.

7. The autorotation controller of claim 6, wherein the desired trajectory is further based on altitude.

8. The autorotation controller of claim 6, wherein the predicted time to ground impact value is calculated as −h/\dot{h}, where h is an altitude value received by the controller and \dot{h} is vertical velocity value received by the controller.

9. The autorotation controller of claim 6, wherein in response to the failure event, the autorotation controller selects at least one of an altitude, forward speed, rotor rotation rate, and vertical velocity values available as input to the autorotation controller for generating a change in collective rotor setting.

10. The autorotation controller of claim 6, wherein in response to the failure event, the autorotation controller selects at least one of an altitude, forward speed, rotor rotation rate, and vertical velocity values available as input to the autorotation controller for generating a collective rotor setting.

11. The autorotation controller of claim 6, wherein in response to the failure event and continuously until a landed state is met, the autorotation controller is configured to:
determine a descent phase,
calculate the predicted time to ground impact using at least one of an altitude, forward speed, rotor rotation rate, and vertical velocity values available as input to the autorotation controller and selected for use based on the descent phase, and
generate an adjusted trajectory.

12. The autorotation controller of claim 6, wherein the predicted time to ground impact value is used to determine descent phase of a helicopter in autorotation, wherein the desired trajectory is adjusted according to a determined descent phase control.

13. An autopilot system comprising:
a controller configured to adjust a desired trajectory based on a predicted time to ground impact value continuously calculated in response to a failure event and to adjust a rotor pitch control, wherein the desired trajectory comprises a forward speed value; and
a velocity tracking controller receiving the forward speed value from the controller to adjust tail and cyclic pitch controls.

14. The autopilot system of claim 13, further comprising:
a touchdown control, wherein the touchdown control is configured to output a constant rotor pitch control in response to a determination of a touchdown descent phase using the predicted time to ground impact value.

15. The autopilot system of claim 13, wherein the desired trajectory further comprises a maximum pitch and roll value, wherein the velocity tracking controller receives the maximum pitch and roll value.

16. The autopilot system of claim 13, wherein the velocity tracking controller comprises a landing site seeking controller.

17. The autopilot system of claim 13, further comprising:
a flare control, wherein the flare control is configured to determine a desired time to impact and output a rotor pitch control for the desired time to impact in response to a determination of a flare descent phase using the predicted time to ground impact value.
